(19) United States
(12) Patent Application Publication
(10) Pub. No.: US 2005/0133649 A1
(43) Pub. Date: Jun. 23, 2005

(54) Cover for food processing appliance with enlarged ingress area

(75) Inventors: Theodore B. Mulle, New Milford, CT (US); Colin Michael Kernan, Hingham, MA (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/738,364

(22) Filed: Dec. 17, 2003

(51) Int. Cl. B02C 19/00

(52) U.S. Cl. 241/301

(57) ABSTRACT

A cover assembly for a food processing appliance having a cover that cooperates with a working bowl or container, which in turn cooperates with an operating and/or control base. The cover has an ingress area, and the operating base has a rotatable processing tool with one or more peripheral impact regions. The cover assembly may also have an accessory for cooperating with the ingress area. The accessory and cover may be operatively connected to a safety system associated with the food processing appliance. In operation, the ingress area of the cover overlies the one or more impact regions of the processing tool without overlying the center of rotation thereof, and at least substantially overlies an impact region at the outermost periphery of the diameter of the processing tool.

### BACKGROUND OF THE INVENTION

1. Field of the Invention

The present invention relates to food processing appliances. More particularly, the present invention relates to a cover for food processing appliances.

2. Description of the Related Art

Appliances for performing preparing/processing food are well known. A food processing appliance, for example, is commonly used to prepare food by mixing, grinding, chopping, slicing, grating, shredding, or by a variety of other processing operations. Typically, these appliances include a container that cooperates with a variety of different food processing tools via an operating and/or control base to perform a corresponding variety of different food processing operations required by an operator of the appliance.

A removable cover is typically used to cover or seal the container during operation of the appliance. These covers frequently have an opening for introducing foodstuff to be processed through the cover into the container. An accessory is often used to push foodstuff to be processed through the opening into engagement with a processing tool.

It is also known to provide these appliances with various safety features that operate to prevent the appliance from operating until the various components of the appliance are properly assembled and/or connected. Numerous safety features have been shown to perform in accordance with regulations set forth by various world-wide safety and testing organizations. For example, in the case of the opening for introducing foodstuff to be processed through the cover into the container, the opening often has a limited cross-sectional area. This has meant that a larger piece of foodstuff must be pre-cut into smaller pieces so that the foodstuff may be introduced through the cover into the container. Consequently, the flexibility of use associated with such appliances is somewhat inhibited. Accordingly, it is desirable to provide a cover for a food processing appliance that maximizes an ingress area while still preserving safety and thereby provide greater flexibility in use.

### SUMMARY OF THE INVENTION

It is an object of the present invention to provide a cover for use with a food processing appliance that provides the food processing appliance with greater flexibility in use.

It is another object of the present invention to provide a cover for a food processing appliance that maximizes the foodstuff ingress area thereof.

It is still another object of the present invention to provide a cover for a food processing appliance that makes better use of the inherent physics exhibited by a rapidly spinning or rotating processing tool.

It is a further object of the present invention to provide a cover for a food processing appliance that improves foodstuff processing efficiency by taking advantage of the processing tool geometry at a periphery of the processing tool diameter.

It is still a further object of the present invention to provide a cover for a food processing appliance with an accessory that can be selectively positioned in relation to the ingress area to facilitate a variety of different operations.

It is yet a further object of the present invention to provide a cover for a food processing appliance that increases the amount of foodstuff effectively processed at the processing tool periphery.

It is another object of the present invention to provide a cover assembly for a food processing appliance that includes a cover and accessory tool operatively connected to a safety system.

These and other objects and advantages of the present invention are achieved by a cover assembly for a food processing appliance having a cover that cooperates with a working bowl or container, which in turn cooperates with an operating and/or control base. The cover has a relatively enlarged ingress area and the operating base has a rotatable processing tool with a peripheral impact region. The cover assembly may also have an accessory for cooperating with the ingress area. The accessory and cover may be operatively connected to a safety system associated with the food processing appliance.

### BRIEF DESCRIPTION OF THE DRAWINGS

Other and further objects, advantages and features of the present invention will be understood by reference to the following specification in conjunction with the accompanying drawings, in which like reference characters denote like elements of structure.

FIG. 1 is a top plan view of a cover for a food processing appliance as known in the prior art.

FIG. 2 is an exploded side view of a food processing appliance having a cover assembly in accordance with an illustrative embodiment of the present invention;

FIG. 3 is a side section view of the food processing appliance and cover assembly of FIG. 2;

FIG. 4 is a top plan view of a cover in accordance with a preferred embodiment of the present invention; and

FIG. 5 is a top plan view of a cover in accordance with an alternative embodiment of the present invention.

### DETAILED DESCRIPTION OF THE INVENTION

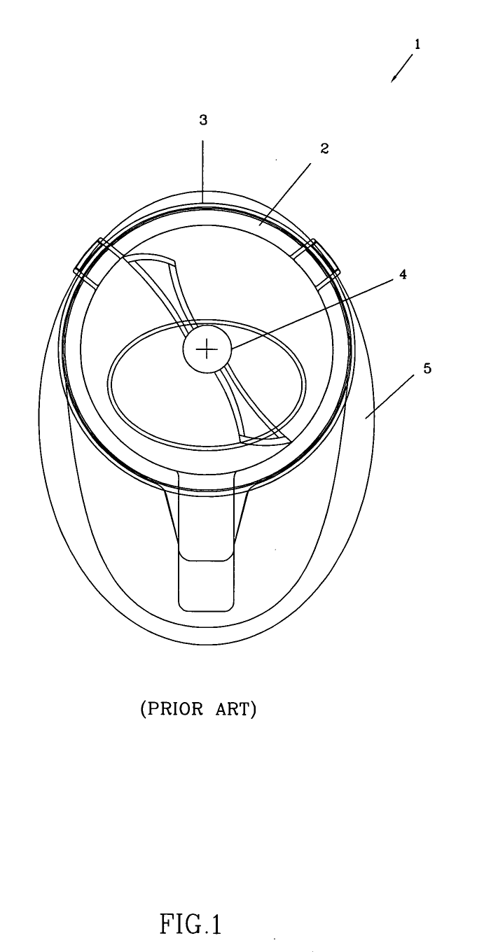

Referring to the drawings and in particular to FIG. 1, there is shown a cover for a food processing appliance 1 as known in the art. As shown, a conventional cover 2, in use, is secured to a container 3 so as to be directly above a processing tool 4 operatively connected to an operating base 5. Although not shown, the food processing appliance may have a safety system associated therewith. For example, it is common to use a vertically movable rod (not shown) that is positioned in a channel (not shown) on a side of container 3, and that is spring-biased toward an upper end of the channel. When container 3 is properly positioned and/or secured to safely cooperate with operating base 5, the rod is aligned with an actuator (not shown) such that when cover 2 is properly positioned and/or secured to container 3, the actuator is depressed against the force of the spring-bias to operate an interlock switch (not shown).

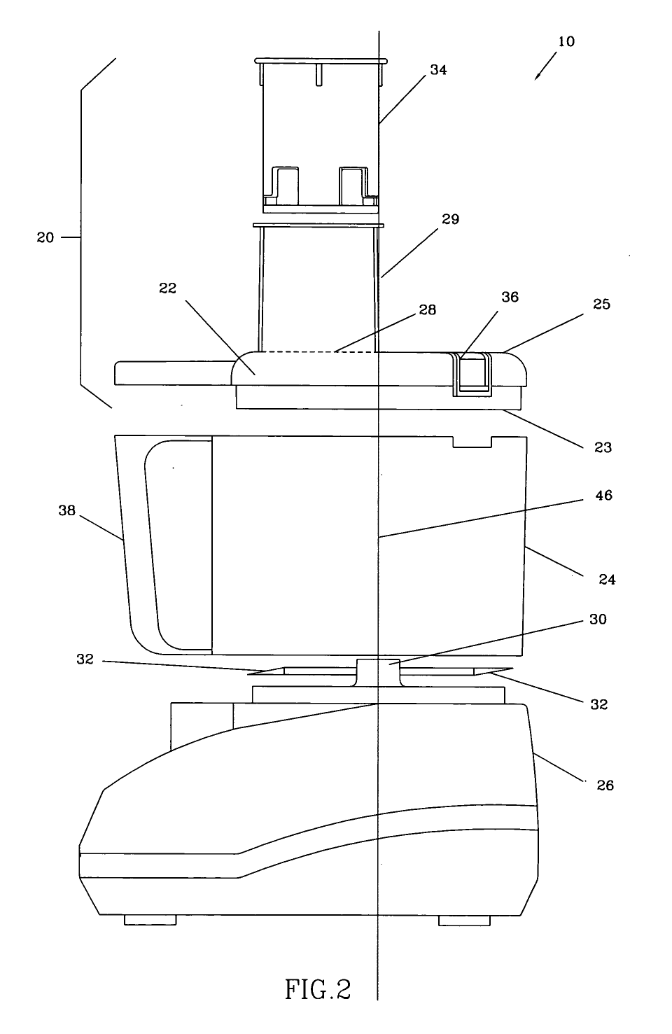

Referring to FIG. 2, an illustrative embodiment of a food processing appliance 10 is shown in association with an improved cover assembly generally represented by reference numeral 20. The cover assembly 20 essentially has a cover 22 for cooperating with a container 24, which in turn cooperates with a control and/or operational base 26. Cover 22 has an ingress area 28, and operating base 26 has a rotatable processing tool 30 with one or more peripheral impact regions 32.

Cover assembly 20 may also have an accessory 34 for cooperating with ingress area 28. For example, if cover 22 has an enlarged ingress area 28, as is the case in the present invention, accessory 34 may be suitably sized to completely cover ingress area 28 and may operatively connect to a safety system (not shown) associated with cover 22 and/or appliance 10 so that appliance 10 cannot be operated unless accessory 34 is properly secured into position covering ingress area 28. For example, in operation, accessory 34 may cooperate with an interlock activating rod (not shown) possibly positioned in cover 22, such as in a channel (not shown) in the cover, to either directly or indirectly activate an interlock switch (not shown) and thereby enable appliance 10 to be operated.

It is noted that the safety system may also be provided with a disengaging assembly that cooperates with the cover and accessory to selectively deactivate or disengage the safety system so that the cover and the accessory can be simultaneously separated and removed from the food processing appliance 10 or adjusted relative to each other and/or the food processing appliance.

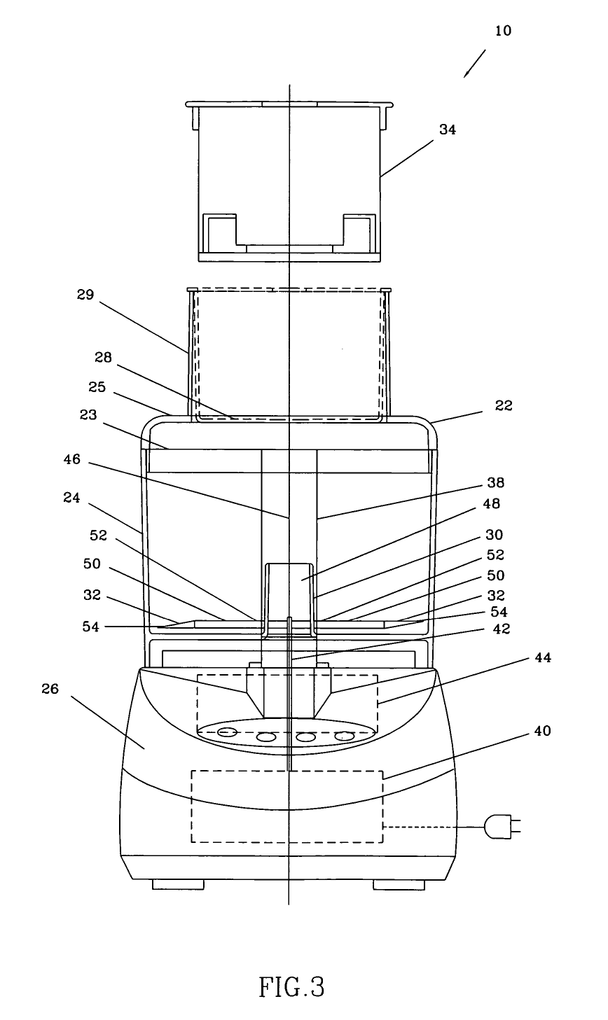

Referring now to FIGS. 2 and 3, cover 22 may preferably be separably connected to container 24 in any of a variety of ways. For example, cover 22 and container 24 may be threadably engaged and disengaged. Alternatively, as shown, cover 22 may be removably secured to container 24 by one or more connectors 36. Cover 22 can have any of a variety of forms, shapes, sizes and/or configurations. For instance, in a preferred aspect of the present invention, cover 22 may have a first, lower side 23 preferably having a first cross-sectional area suitable for cooperating with container 24 and a second, upper side 25 with ingress area 28 having a second cross-sectional area therein. In one aspect of the present invention, the cross-sectional area of ingress area 28 of upper side 25 is substantially equal to about half the cross-sectional area of lower side 23 of cover 22.

Container 24 is preferably of sufficient size and/or shape to accommodate a wide variety of different types of foodstuff or substances in a variety of shapes, sizes or forms. Container 24 can have a handle 38. Container 24 preferably cooperates with base 26 so that processing tool 30, which is preferably operatively connected to a drive motor 40 via a drive shaft 42, may influence or impact any of a variety of different foodstuffs while such foodstuff is held in container 24. Thus, processing tool 30 preferably cooperates with drive motor 40 through both container 24 and base 26. It will be noted that the speed at which processing tool 30 is operated may preferably be controlled or manipulated by the safety system and/or a control panel 44 operatively connected to drive motor 40.

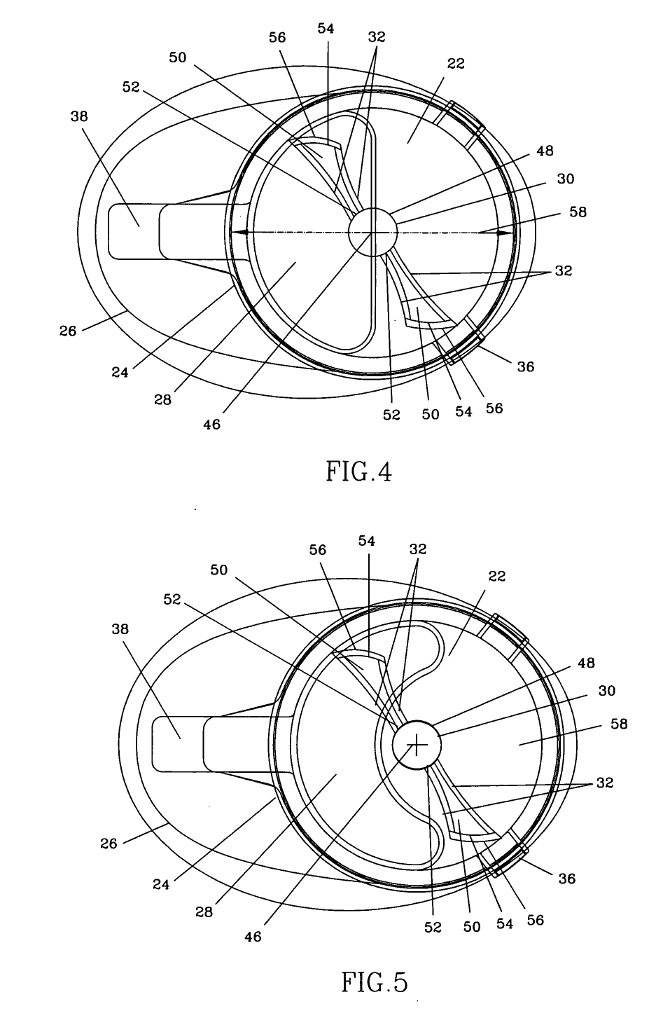

Referring to FIG. 4, in a preferred embodiment of the present invention, processing tool 30 preferably has a center of rotation 46 and one or more impact regions 32. For example, as shown, processing tool 30 may have a hub 48 with one or more blades 50 operatively connectable to drive motor 40 via drive shaft 42. Each blade 50 may preferably have a proximal end 52 connected to hub 48 and/or proximate center of rotation 46, and a distal end 54 spaced a predefined distance from hub 48 and/or center of rotation 46. Each blade 50 may preferably have at least one impact point, area or region 32 at which such blade directly interacts with or impacts foodstuff to accomplish a desired processing effect (e.g., cut, chop, slice, dice, etc.).

In a preferred aspect of the present invention, the inherent physics exhibited by a rapidly spinning or rotating processing tool 30 preferably oriented perpendicular in relation to foodstuff to be processed may preferably be utilized. That is, the present invention preferably takes advantage of the relationship between linear velocity and a magnitude force that is tangential to a vector. This vector relationship may be represented as follows:
V_{L}=ωr
where V_{L} represents a linear velocity at a given point, ω represents an angular velocity of a processing blade, and r represents the radius of the processing blade impact point or the distance from the center of rotation 46 to a particular impact region 32. It can be seen from this basic relationship that as the value of r increases, that is, as one moves outwardly, away from hub 48 and/or center of rotation 46, there is a linear change in the velocity. It follows then, from the following relationship:
Fₜ=mV_{L}²=mωr
where Fₜ represents a tangential impact force in pounds per linear foot (lbf), for example, and m represents the mass of a particular processing tool 30 (lbf), that certain processing operations (e.g., slicing) may be enhanced or improved by capitalizing on the impact force on foodstuff during processing, and preferably at the early stages of processing. That is, processing efficiency may be improved by taking advantage of the geometry of processing tool 30, and more particularly, the geometry of processing tool 30 at an impact region near a periphery 56 of the processing tool diameter or at distal end 54 thereof, which, in operation, may closely proximate an inner diameter 58 of container 24.

Referring still to FIG. 4, in a preferred aspect of the present invention, ingress area 28 may preferably be sized and/or shaped to overly one or more impact regions 32 without overlapping center of rotation 46. For example, in one embodiment, ingress area 28 may have a substantially “D” shape as shown in FIG. 4. In another embodiment, as shown in FIG. 5, ingress area 28 may have an overall “C” shape. Irrespective of the particular shape of ingress area 28, when cover 22 is operatively connected to container 24 and container 24 operatively connected to base 26, ingress area 28 preferably overlies one or more impact regions 32. More preferably, ingress area 28 overlies the impact region 32 at periphery 56 of processing tool 30, or in the case of blades 50, the outermost impact region 32 at each distal end 54 thereof.

Referring to FIG. 3, in addition to the foregoing, it is noted that accessory 34 can have any of a variety of different shapes, sizes and/or configurations suitable for complimenting and/or facilitating a variety of different preliminary processing operations. Accessory 34 may also be provided with an actuator (not shown) for either directly or indirectly satisfying the safety system, which in turn may actuate a control switch (not shown) operatively connected to control panel 44 and/or drive motor 40.

Thus, food processing appliance 10, in at least one aspect of the present invention, will preferably remain inoperative until accessory 34 properly engages ingress area 28 of cover 22 thereby preventing entry of a hand or an undesirable foreign object through the cover 22 and into the container 24. Once accessory 34 is properly engaged with ingress area 28, the safety system is preferably satisfied and the food processing appliance 10 may be operated. Ordinarily, when accessory 34 is removed and/or separated from ingress area 28, the safety system is preferably disengaged or deactivated, and the food processing appliance 10 becomes inoperative once again.

The present invention having been thus described with particular reference to the preferred forms thereof, it will be obvious that various changes and modifications may be made therein without departing from the spirit and scope of the present invention as defined herein. In addition, it is believed that the many advantages of this invention and the manner in which it fulfills the stated objectives will be understood by those skilled in the art.

1. A cover assembly for a food processing appliance comprising:
a cover for cooperating with a container, said container cooperating with an operating base, said cover having an upper side with a predefined ingress area and said operating base having a rotating tool with a center of rotation and a peripheral impact region, said peripheral impact region being radially distanced from said center of rotation; and
an accessory for cooperating with said ingress area,
wherein said ingress area overlies said peripheral impact region without overlapping said center of rotation.

2. The cover assembly of claim 1, wherein said ingress area has a cross-sectional area substantially equal to half that of a lower side of said cover.

3. The cover assembly of claim 1, wherein said ingress area is sized to increase the volume of foodstuff that may be passed therethrough.

4. The cover assembly of claim 1, wherein said ingress area is shaped so as to optimize a processing effect of said rotating tool.

5. The cover of claim 4, wherein said processing effect can be an effect selected from a group consisting of cutting, slicing, chopping, grinding, mincing, dicing, hashing, pureeing, liquefying, and/or mixing.

6. The cover assembly of claim 1, wherein said ingress area is sized and shaped to take advantage of the geometry of said rotating tool at said peripheral impact region thereof.

7. A cover for a food processing appliance comprising:
a first side for cooperating with a container, said container cooperating with an operating base, said operating base having one or more rotating blades with a center of rotation, and one or more impact regions, said one or more impact regions being distanced radially from said center of rotation; and
a second side, opposite said first side, having an ingress area for cooperating with an accessory tool,
wherein said ingress area overlies said one or more impact regions without overlapping said center of rotation when the cover is operatively connected to said container and said container is operatively connected to said operating base.

8. The cover of claim 7, wherein said ingress area has a cross-sectional area substantially equal to half the cross-sectional area of the cover.

9. The cover of claim 7, wherein said ingress area is sized to increase the amount of foodstuff that may be passed therethrough at one time.

10. The cover of claim 7, wherein said ingress area is shaped to optimize the processing effect of said one or more rotating blades.

11. The cover of claim 10, wherein said processing effect can be an effect selected from a group consisting of cutting, slicing, chopping, grinding, mincing, dicing, hashing, pureeing, liquefying, and/or mixing.

12. The cover of claim 7, wherein said ingress area is sized and shaped so that the geometry of said one or more rotating blades at said one or more impact regions is utilized.

13. A cover for a food processing appliance comprising:
a body operatively connectable to a container, said container being operatively connectable to a base, said base having one or more processing tools with one or more impact regions rotatable about a center of rotation, said one or more impact regions being distanced radially from said center of rotation; and
an ingress area in said body so that when the cover is operatively connected to said container and said container is operatively connected to said operating base, said ingress area overlies said one or more impact regions without overlapping said center of rotation.

14. The cover of claim 13, wherein said ingress area has a cross-sectional area substantially equal to half a cross-sectional area of said body.

15. The cover of claim 13, wherein said ingress area is sized to increase the amount of foodstuff that may be passed therethrough at one time.

16. The cover of claim 13, wherein said ingress area is shaped to optimize the processing effect of said one or more processing tools.

17. The cover of claim 16, wherein said processing effect can be any effect selected from a group consisting of cutting, slicing, chopping, grinding, mincing, dicing, hashing, pureeing, liquefying, and/or mixing.

18. The cover of claim 13, wherein said ingress area is sized and shaped to take advantage of the geometry of said one or more processing tools at said one or more impact regions thereof.

19. The cover of claim 13, wherein at least one of said one or more processing tools is a spinning blade having a proximal end near said center of rotation and a distal end distanced from said center of rotation, said spinning blade being oriented perpendicular to foodstuff that is passed through said ingress area.

20. The cover of claim 19, wherein said ingress area is sized and/or shaped to allow at least a substantial portion of an outermost impact region to effectively interact with said foodstuff, said outermost impact region being at said distal end of said spinning blade.
